(19) United States
(12) Patent Application Publication
(10) Pub. No.: US 2022/0297347 A1
(43) Pub. Date: Sep. 22, 2022

(54) MACHINE FOR CUTTING SLABS, PARTICULARLY MADE OF MARBLE, GRANITE, GLASS AND COMPOSITE MATERIALS

(71) Applicant: Helios Automazioni S.R.L., Mugnano di Napoli (IT)

(72) Inventor: Antonio Fontana, Mugnano di Napoli (IT)

(73) Assignee: Helios Automazioni S.R.L., Mugnano di Napoli (IT)

(21) Appl. No.: 17/633,507

(22) PCT Filed: Aug. 3, 2020
(86) PCT No.: PCT/IB2020/057328

§ 371 Date: Feb. 7, 2022

(30) Foreign Application Priority Data
Aug. 8, 2019 (IT) 102019000014460

(51) Int. Cl. B28D 1/04; B28D 7/04

(52) U.S. Cl. CPC B28D 1/043; B28D 7/04

(57) ABSTRACT

The machine comprises: one base frame; one worktop for at least one slab, associated with the base frame; one cutting head adapted to cut the slab, associated with the base frame by interposition of one transverse frame moveable along a first direction, the cutting head being moveable on the transverse frame along a second direction transverse with respect to the first direction; gripping means of the slab, associated with the base frame and moveable sliding with respect to the base frame along the first direction; wherein the gripping means are associated with the transverse frame and moveable on it along the second direction independently with respect to the cutting head.

### TECHNICAL FIELD

The present invention relates to a machine for cutting slabs, particularly made of marble, granite, glass and composite materials.

### BACKGROUND ART

Machines designed to cut slabs made of marble or other materials are well known and are provided with a horizontal worktop, on which the slab being machined is loaded, and with a cutting blade, e.g. a diamond disc or the like, which is moveable above the worktop by means of dedicated movement means.

The movement means consist, e.g., of a series of Cartesian guides that carry the cutting blade on a moveable beam and move it along the three Cartesian axes, i.e. the two horizontal directions and the vertical direction.

The moveable beam and, more generally, the movement means of the cutting blade are also associated with special auxiliary means intended to the movement of the slab to be cut and/or of the slab cut on the worktop, and possibly for its vertical clamping.

The use of these auxiliary means, however, takes time away from the actual machining of the cutting blade during the movement phase, significantly slowing down the operations and reducing the production output of the machine.

For this reason, the operator sometimes prefers to displace or hold the slab manually in order to lose as little time as possible; however, this behavior risks compromising their safety.

It is easy to understand, in fact, that displacing or holding the slab with one's hands while the cutting blade is in operation can cause serious injury to the operator.

In addition, the movement of large slabs is particularly tiring and dangerous for the health of the operator's musculoskeletal system.

The aforementioned problems are partly fixed by patent EP3049205, which describes a slab cutting machine that uses gripping means moveable with respect to the base frame to hold the entire slab or parts thereof after cutting.

In particular, the gripping means described by EP3049205 are associated with a respective moveable beam that allows it to be positioned in relation to the worktop along the three Cartesian axes.

This machine is susceptible to being improved.

The machine described by EP3049205, in fact, provides that the gripping means and the cutting head are associated with the frame by interposition of separate and independent movement means.

This implies the presence of a large number of structural elements that make the work area particularly cumbersome with greater risks for the operators' safety. Moreover, the considerable structural complexity of this type of machine implies high manufacturing costs which inevitably affect the selling prices of the slabs.

Another machine of known type for cutting slabs is described in document WO2014/207723 A1.

The machine described by WO2014/207723A1 has a base frame with which a transverse frame carrying one or more working heads is associated moveable sliding along a first direction.

The transverse frame consists of a crossbeam which is associated in a moveable manner with the main frame along the first direction and of a supporting structure associated in a rotatable manner with the crossbeam around a relevant axis of rotation, on which the working heads are mounted.

The working heads are associated with the supporting structure and are moveable along a second direction transverse to the first direction on relevant guides associated with the supporting structure itself. The working heads are therefore integral in rotation around the axis.

In addition, each working head is, in turn, rotatable around its own axis of work. This way the working heads are positionable at several points of the slab in order to carry out the corresponding machining operations.

It is clear that the solution described by WO2014/207723A1 also implies the presence of a large number of structural elements that make the work area particularly cumbersome. Consequently, it is easy to understand how even the machine described by WO2014/207723A1 requires high manufacturing costs which inevitably affect the sales prices of the slabs.

### DESCRIPTION OF THE INVENTION

The main aim of the present invention is to devise a machine for cutting slabs, particularly made of marble, granite, glass and composite materials, which is of greater structural simplicity than the machines of known type.

As part of this technical aim, a further object of the present invention is to make the work area less cumbersome and safer for operators.

Another object of the present invention is to devise a machine for cutting slabs, particularly made of marble, granite, glass and composite materials, which allows reducing the costs related to the manufacturing of the machine itself. Another object of the present invention is to devise a machine for cutting slabs, particularly made of marble, granite, glass and composite materials, which allows overcoming the aforementioned drawbacks of the prior art in a simple, rational, easy, effective to use and affordable solution.

The aforementioned objects are achieved by the present machine for cutting slabs, particularly made of marble, granite, glass and composite materials, having the characteristics of claim 1.

### BRIEF DESCRIPTION OF THE DRAWINGS

Other characteristics and advantages of the present invention will be more evident from the description of a preferred, but not exclusive, embodiment of a machine for cutting slabs, particularly made of marble, granite, glass and composite materials, illustrated by way of an indicative, yet non-limiting, example in the attached tables of drawings in which:

FIGS. 1-2 are axonometric views, from different angles, of a first embodiment of the slab cutting machine according to the invention;

FIGS. 3-6 are axonometric views of machine components in FIGS. 1 and 2 for cutting slabs according to the invention.

FIGS. 7-11 are axonometric views of a second embodiment of the gripping means according to the invention.

### EMBODIMENTS OF THE INVENTION

With particular reference to these figures, reference numeral 1 globally indicates a machine for cutting slabs, particularly made of marble, granite, glass and composite materials.

The machine 1 comprises at least one base frame 2, 3 for resting on the ground. The base frame 2, 3 comprises a bedplate 2 and two walls 3 rising from opposite sides of the bedplate 2.

The machine 1 comprises at least one worktop 4 for at least one slab L to be cut, which is associated with the base frame 2, 3.

The worktop 4 is substantially horizontal, it extends between the two walls 3 and thereon is positioned the slab L to be cut.

In particular, the slab L is made of a material selected from marble, granite, glass and composite materials. It cannot however be ruled out that the slab L is made of any other material suitable to be cut by means of the machine 1 according to the present invention.

The machine 1 comprises at least one cutting head 5 adapted to cut the slab L. The cutting head 5 comprises a cutting tool 6 of the type of a disc blade or the like.

The cutting head 5 is associated with the base frame 2, 3 and is moveable with respect thereto along a first direction A substantially parallel to the worktop 4. In more detail, the cutting head 5 is associated with the base frame 2, 3 by interposition of at least one transverse frame 7a, 7b moveable sliding with respect to the base frame 2, 3 to displace the cutting head itself along the first direction A.

In more detail, as shown in the figures, the transverse frame 7a, 7b comprises:
a first crossbeam 7a extending along the second direction B and on which the cutting head 5 is mounted; and
a second crossbeam 7b extending along the second direction B and locked together with the first crossbeam 7a.

In addition, the second crossbeam 7b is positioned at a lower height than the first crossbeam 7a, i.e., it is closer to the slab L than the first crossbeam 7a.

The machine 1 comprises a guiding unit 8, associated with the base frame 2, 3 and with which the transverse frame 7a, 7b is associated by sliding.

Specifically, the transverse frame 7a, 7b is associated with the base frame 2, 3 through the first crossbeam 7a that extends between the walls 3.

The guiding unit 8 comprises at least one pair of rails 8, wherein each rail 8 is mounted at the top of a respective wall 3.

The rails 8 extend along the first direction A, horizontally and parallel to the walls 3.

Advantageously, the machine 1 comprises at least one movement assembly 9, 10, 14 adapted to move the transverse frame 7a, 7b with respect to the base frame 2, 3 along the first direction A.

The movement assembly 9, 10, 14 comprises an actuator device 9 mounted on the transverse frame 7a, 7b and connected through a drive system 10 to the base frame 2, 3.

The actuator device 9 and the drive system 10 are mounted on the first crossbeam 7a.

The actuator device 9 is of the type, e.g., of an electric motor.

The drive system 10 comprises at least one pair of end wheels 12a, each mounted at one respective end of the transverse frame 7a, 7b.

Each of the end wheels 12a is associated with a relevant first threaded nut 13, which is screwed around a relevant first threaded shaft 14, substantially parallel to the rails 8 and mounted on a respective wall 3.

The drive system 10 also comprises at least one main flexible element 11a closed on itself in a loop and wound at least partly around the end wheels 12a. The main flexible element 11a may be of the type of a belt, a chain, a rope or the like.

Conveniently, the drive system 10 comprises a plurality of flexible elements 11. Specifically, the drive system 10 comprises at least two main flexible elements 11a, each at least partly wound around a relevant end wheel 12a.

In addition, the drive system 10 comprises at least one idler wheel 12b mounted at an intermediate area of the transverse frame 7a, 7b.

Specifically, the at least one idler wheel 12b is mounted on the first crossbeam 7a.

The flexible elements 11a, 11b are wound at least partly around the at least one idler wheel 12b.

More in detail, each main flexible element 11a is wound at least partly to a relevant end wheel 12a and to the at least one idler wheel 12b.

The actuator device 9 is associated with the at least one idler wheel 12b.

The rotation of the idler wheel 12b causes the rotation of the end wheels 12a due to the transmission of motion given by the flexible elements 11a, 11b. Advantageously, the drive system 10 comprises a plurality of idler wheels 12b mounted at the intermediate areas of the transverse frame 7a, 7b and at least one idler flexible element 11b at least partly wound around two of the idler wheels 12b.

The idler flexible element 11b is positioned between the main flexible elements 11a.

The idler wheels 12b are arranged in two pairs in which each idler wheel 12b of the pair is associated with a relevant flexible element 11a, 11b.

The idler wheels 12b of the same pair are associated, one with a relevant main flexible element 11a and the other with the idler flexible element 11b.

The idler wheels 12b of the same pair are configured to rotate on the same axis. The actuator device 9 is associated with one of the pairs of idler wheels 12b. The operation of the actuator device 9 involves the rotation of the pair of idler wheels 12b, through which a relevant main flexible element 11a causes the rotation of the relevant end wheel 12a and, consequently, of the relevant first threaded nut 13 on the first threaded shaft 14.

The rotation of the pair of idler wheels 12b by the actuator device 9 also causes the rotation of the other pair of idler wheels 12b through the idler flexible element 11b.

The motion is thus also transmitted to the opposite end wheel 12a, through the relevant main flexible element 11a and, consequently, the relevant first threaded nut 13 on the first threaded shaft 14.

The movement assembly 9, 10, 14 allows, therefore, through a single actuator device 9 to move the ends of the transverse frame 7a, 7b in a perfectly synchronous manner along the first direction A.

This embodiment allows the transverse frame 7a, 7b to be moved evenly along the first direction A and to position it in an extremely precise manner with respect to the slab L.

In fact, if, for example, the movement assembly 9, 10, 14 comprised two separate actuator devices 9, each associated with a relevant first threaded nut 13, it would be necessary to set the parameters for the frequency of rotation of the latter in an extremely precise manner.

Differences in the frequency of rotation, even if minimal, may alter the movement and position of the transverse frame 7a, 7b, leading to even major damage to the machine, as well as jeopardizing the machining operations.

It is clear to the industry technician that such frequency parameter settings are not easy to implement.

The movement assembly 9, 10, 14 according to the present invention allows, therefore, fixing also the above-mentioned drawback.

In addition, it should be noticed that the drive system 10 is suitably mounted on the same structure that carries the cutting head 5 and the gripping means, i.e. the transverse frame.

This arrangement results in a remarkable simplicity in the construction of the machine 1, as it avoids the assembly of additional load-bearing structures, and helps to limit the size of the work area, thus reducing the risks for the safety of operators.

In addition, the machine 1 comprises gripping means 15, 151, 152 of the slab L, to grasp the slab, or to hold it or to grasp and hold it, associated with the base frame 2, 3.

In more detail, the gripping means 15, 151, 152 have the function of locking the slab L on the worktop 4 in order to allow the cutting head 5 to carry out the cutting operation precisely and easily.

The gripping means 15, 151, 152 are moveable sliding with respect to the base frame 2, 3 along the first direction A, to position themselves at predefined areas of the slab L.

According to the invention, the gripping means 15, 151, 152 are in turn associated with the transverse frame 7a, 7b.

In other words, the movement of the transverse frame 7a, 7b along the first direction A displaces both the cutting head 5 and the gripping means 15, 151, 152 with respect to the base frame 2, 3.

The cutting head 5 and the gripping means 15, 151, 152 are also moveable on the transverse frame 7a, 7b along a second direction B substantially parallel to the worktop 4 and transverse with respect to the first direction A.

In more detail, the second direction B is perpendicular to the first direction A. Specifically, the gripping means 15, 151, 152 are mounted on the second crossbeam 7b.

As shown above, the second crossbeam 7b and, consequently, the gripping means 15, 151, 152 are in the closest position to the slab L with respect to the first crossbeam 7a. This way, the space required for the gripping means 15, 151, 152 can be reduced, while at the same time ensuring optimal gripping of the slab L.

Advantageously, the gripping means 15, 151, 152 are moveable sliding along the second direction B in an independent manner with respect to the cutting head 5. The machine 1 comprises movement means 16, 17 associated with the transverse frame 7a, 7b and adapted to move the cutting head 5 and the gripping means 15, 151, 152 along the second direction B.

The movement means 16, 17 extend along the second direction B.

In particular, the movement means 16, 17 comprise first movement means 16 on which the cutting head 5 is mounted sliding and second movement means 17, different from the first movement means 16, on which the gripping means 15, 151, 152 are mounted sliding.

Substantially, in the machine 1 according to the invention, the transverse frame 7a, 7b sustains both the first movement means 16 that hold the cutting head 5, and the second movement means 17 that hold the gripping means 15, 151, 152. More in detail, the first movement means 16 are mounted on the first crossbeam 7a and the second movement means 17 are mounted on the second crossbeam 7b.

The first movement means 16 and the second movement means 17 are arranged on opposite sides of the transverse frame 7a, 7b with respect to a longitudinal plane P substantially parallel to the second direction B and transverse to the worktop 4.

This embodiment ensures that the cutting head 5 and the gripping means 15, 151, 152 can be moved simultaneously or separately without the motion of one affecting the motion of the others.

The first movement means 16 comprise first rail elements 18 which extend along the second direction B and on which a supporting frame 19 of the cutting head 5, sliding on the first rail elements 18, is mounted.

The supporting frame 19 is moved thanks to a motor body 20 associated with the supporting frame itself, which transfers motion to a wheel element 21 associated with a second threaded nut 22 screwed around a second threaded shaft 23 substantially parallel to the first rail elements 18.

The rotation of the wheel element 21 drags the supporting frame 19 along the second direction B, thus allowing the movement of the cutting head 5.

The second movement means 17 comprise second rail elements 24 extending along the second direction B and on which at least one slide 25 supporting the gripping means 15, 151, 152 is mounted sliding.

The second movement means 17 comprise a rack 26 extending along the second direction B and with which an operating system 27, 28 is associated.

The operating system 27, 28 comprises a motor assembly 27 adapted to move the gripping means 15, 151, 152 along the second direction B.

The motor assembly 27 is associated with a pinion 28 meshing on the rack 26. It is easy to understand, therefore, that the operation of the pinion 28, by the motor assembly 27, drags the slide 25 along the second direction B.

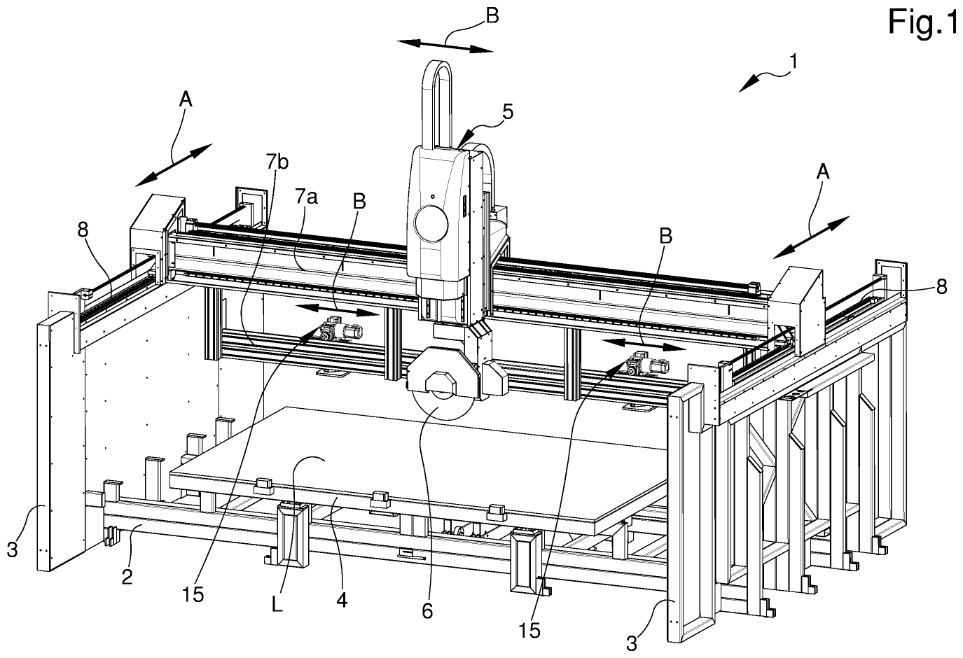

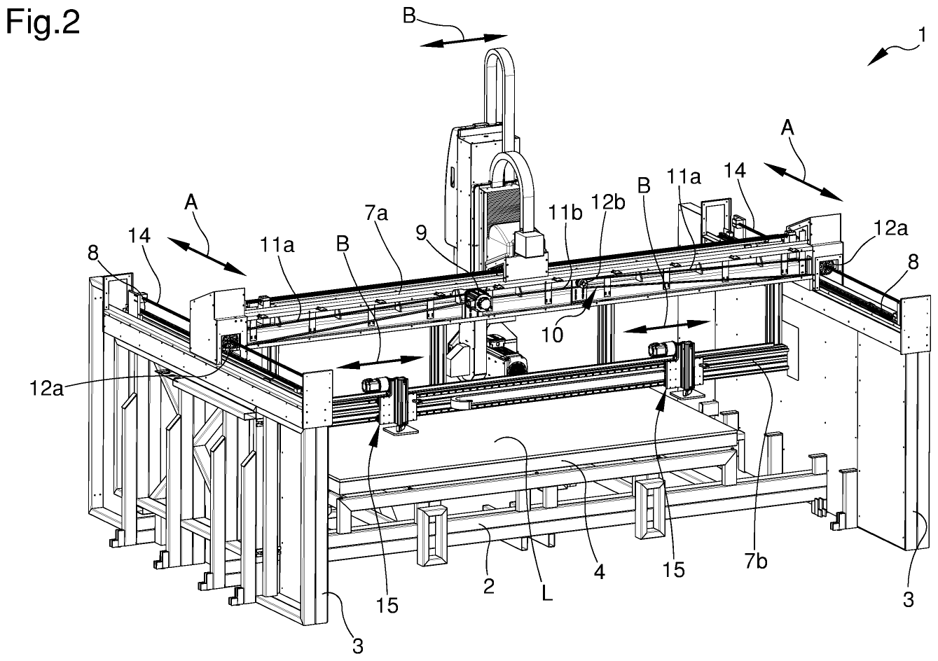

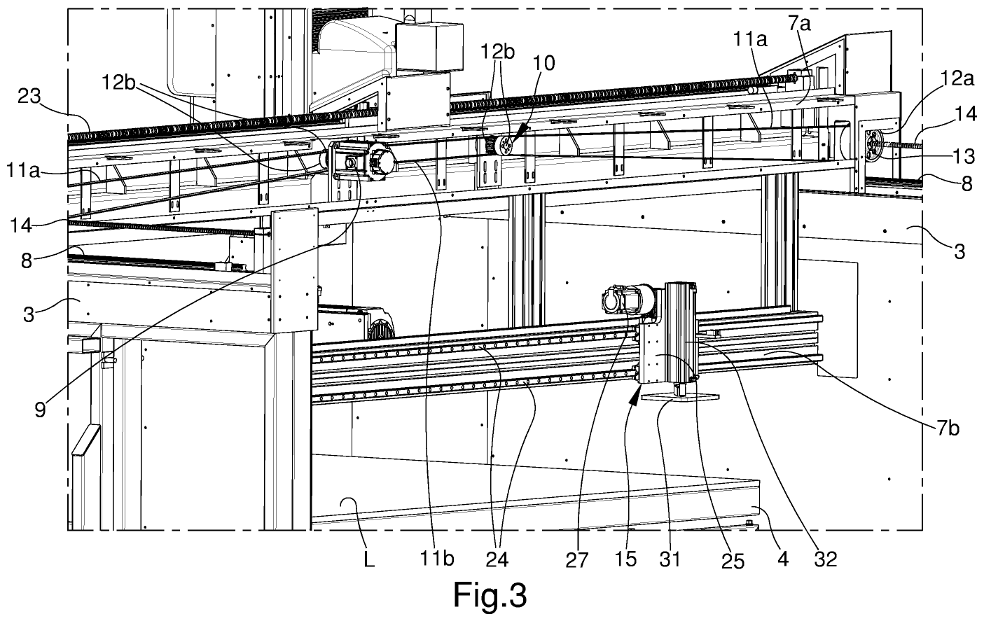

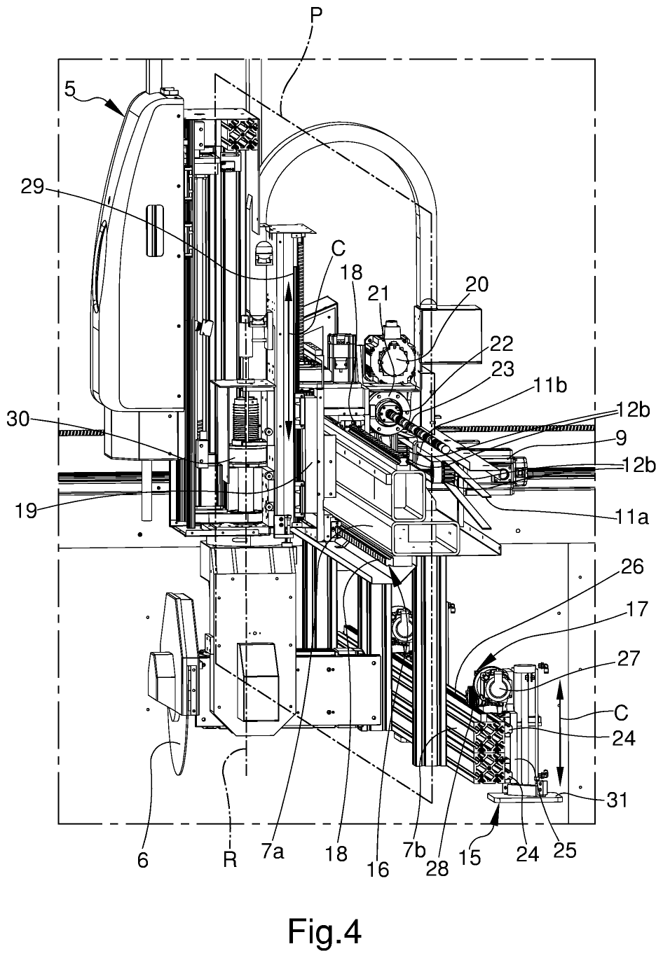

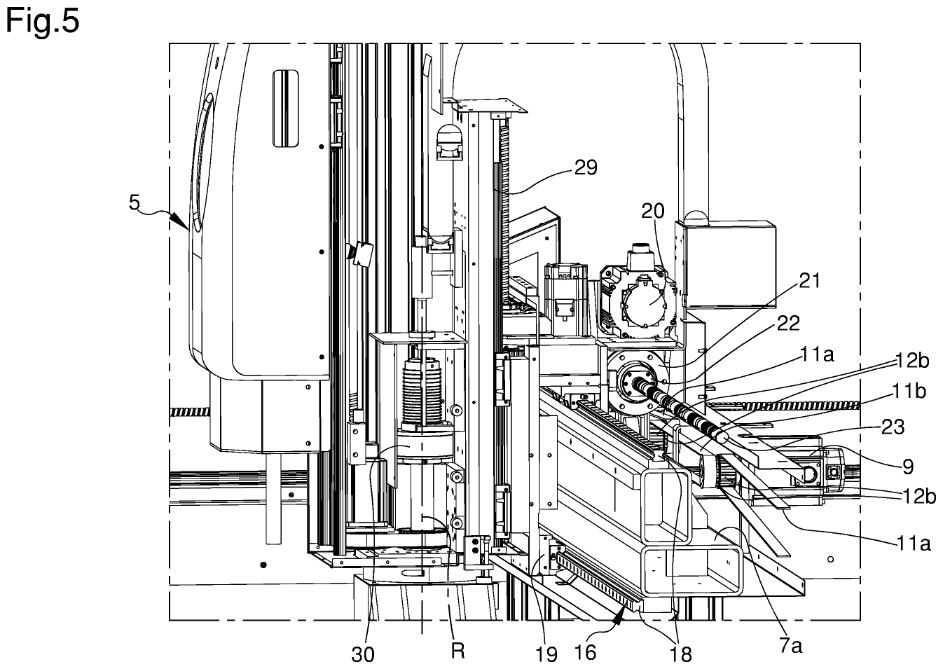

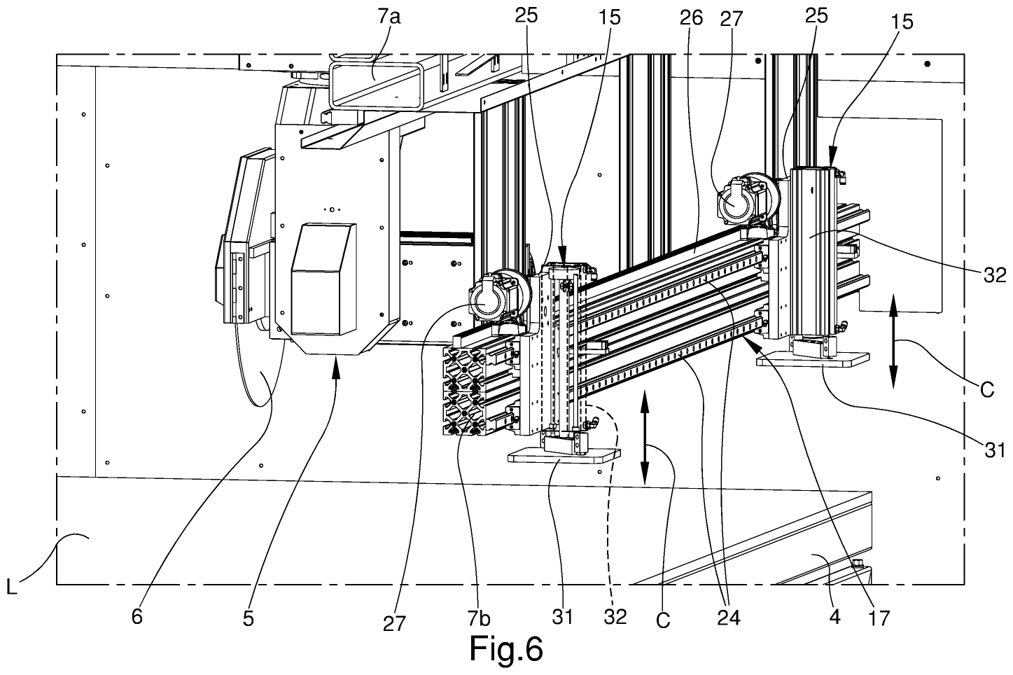

Conveniently, in a first embodiment of the machine 1 shown in FIGS. 1 to 6, the gripping means 15, 151, 152 comprise at least two gripping heads 15, each associated with a respective motor assembly 27 and moveable independently the one with respect to the other along the second direction B.

In more detail, each gripping head 15 is mounted on a respective slide 25 which is moved by a respective operating system 27, 28 meshing on the rack 26.

This particular embodiment allows optimizing the components of the system, being able to use the same rack 26 to move the gripping heads 15 forward independently from each other along the second direction B.

In addition, the cutting head 5 and the gripping means 15 are moveable along a third direction C substantially transverse to the worktop 4 in order to move close to/away from the slab L.

In particular, the third direction C is substantially orthogonal to the worktop 4. In actual facts, the cutting head 5 and the gripping means 15 are able to move along the three Cartesian axes.

The cutting head 5, in fact, is mounted sliding on the supporting frame 19 so as to be able to shift vertically to move close to/away from the slab L.

For this purpose, the cutting head 5 comprises guiding elements 29 extending along the third direction C and with which the supporting frame 19 is associated.

In addition to mobility along the three directions A, B, C, the cutting head 5 is provided with other degrees of freedom that allow the cutting tool 6 to rotate around one or more working axes.

The cutting head 5, e.g., comprises a rotational unit 30, which allows the cutting tool 6 to rotate around a vertical axis of rotation R to change the orientation and inclination of the cutting tool 6 with respect to the worktop 4.

Similarly to the cutting head 5, the gripping means 15, 151, 152 are moveable along the third direction C.

In more detail, each of the gripping heads 15 comprises at least one grasping element 31 adapted to grasp, lift, drag and press the slab L on the worktop 4.

In particular, the grasping element 31 advantageously consists of a suction plate (e.g. vacuum plates, suction cups or the like).

More in detail, the suction plate is shaped so that it extends mainly horizontally and has a rather large contact surface area with the slab L.

The grasping element 31 can perform several tasks:
it can press on the slab L or on portions of the slab L already cut, blocking it against the worktop 4 e.g. during the intervention of the cutting head 5, thus allowing particularly precise cuts to be made even on small pieces;
it can adhere firmly to the slab L to displace it together with the gripping heads 15 along the worktop 4. In this regard, it is underlined that it is not necessary that the suction plate is able to lift the slab L completely with respect to the worktop 4, but it is sufficient that it adheres thereto so as to be dragged horizontally.

The grasping element 31 is moveable along the third direction C to move close to/away from the slab L, which in turn rests on the worktop 4.

Conveniently, each of the gripping heads 15 comprises an actuator element 32 adapted to displace the grasping element 31 along the third direction C.

The actuator element 32 is of the type of a pneumatic cylinder.

The operation of the machine 1 is easily derived from the previous description of its components.

The slab L to be cut is placed on the worktop 4 to undergo the cutting operation. The cutting head 5 and the gripping means 15, 151, 152 are positioned along the first direction A by means of the movement of the transverse frame 7a, 7b on the rails 8.

The cutting head 5 and the gripping means 15, 151, 152 are positioned independently along the second direction B by shifting on the transverse frame 7a, 7b, respectively thanks to the first movement means 16 and to the second movement means 17.

Then the grasping elements 31 are moved along the third direction C close to the slab L in order to grasp, hold and/or drag it onto the worktop 4.

At this point, the cutting head 5 is also moved close to the slab L by shifting on the supporting frame 19 along the third direction C.

The cutting tool 6 is directed, if necessary, by means of the rotational unit 30 and then operated to cut the slab L.

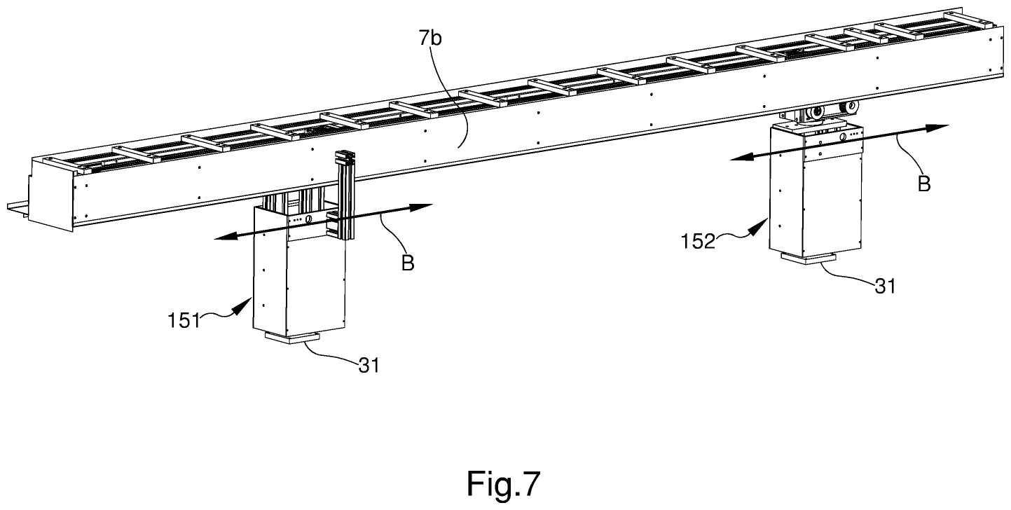

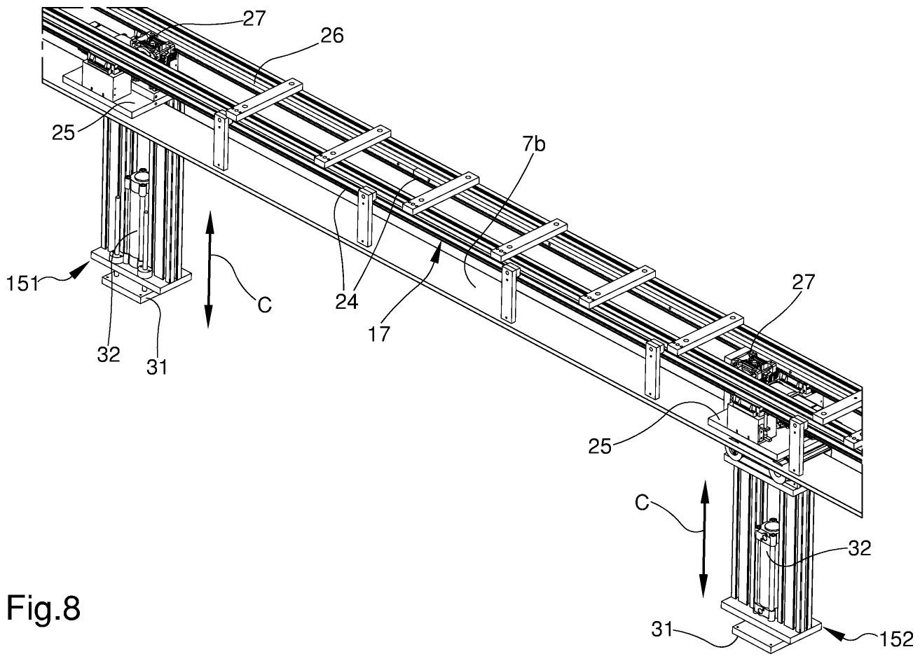

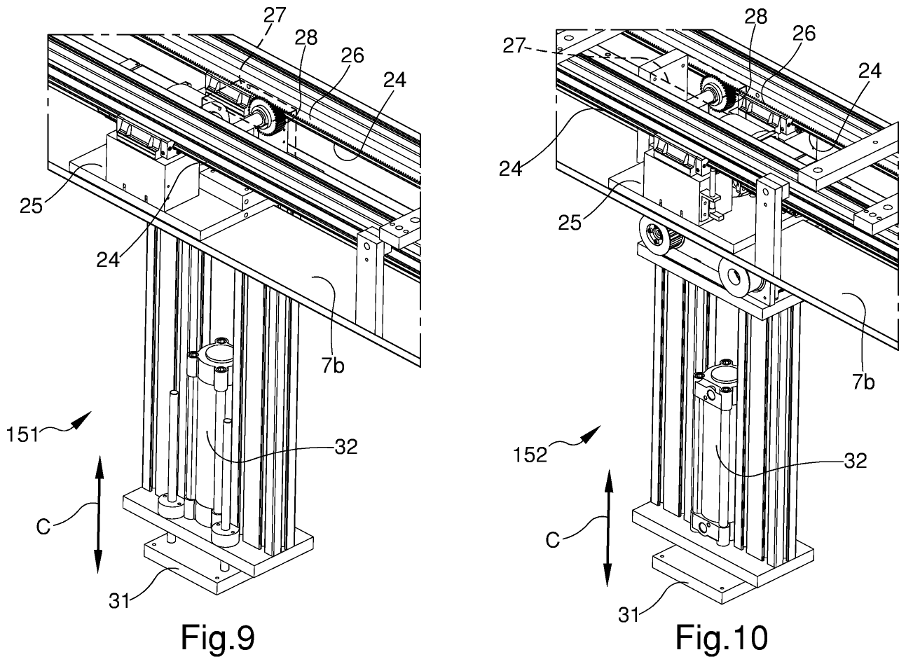

FIGS. 7 to 11 show a second embodiment wherein the reference numbers 151 and 152 indicate two gripping heads that differ from the gripping heads 15 described above in the following way.

With particular reference to FIGS. 7 to 11, therefore, the machine 1 is provided with gripping means 151, 152, wherein at least one of the gripping heads 151, 152 is moveable in rotation around an axis of work W substantially transverse to the worktop 4.

The axis of work W is substantially parallel to the third direction C.

Specifically, similarly to what described above for the first embodiment, the gripping heads 151, 152 are associated with the second crossbeam 7b and moveable sliding along the second direction B.

The movement of the gripping heads on the transverse frame 7a, 7b is similar to the one described for the first embodiment and to the detailed description of which reference is made.

The gripping means 151, 152 comprise at least one gripping head 151 fixed in rotation and at least one gripping head 152 rotatable around the axis of work W. The gripping head 152 comprises a framework assembly 33 which supports at least the grasping element 31 and the relevant actuator element 32.

Substantially, the rotation of the gripping head 152 around the axis of work W causes the rotation of the grasping element 31.

The framework assembly 33 is associated rotatable with the slide 25 around the axis of work W.

The gripping head 152 also comprises an actuating unit 34 adapted to set the framework assembly 33 in rotation.

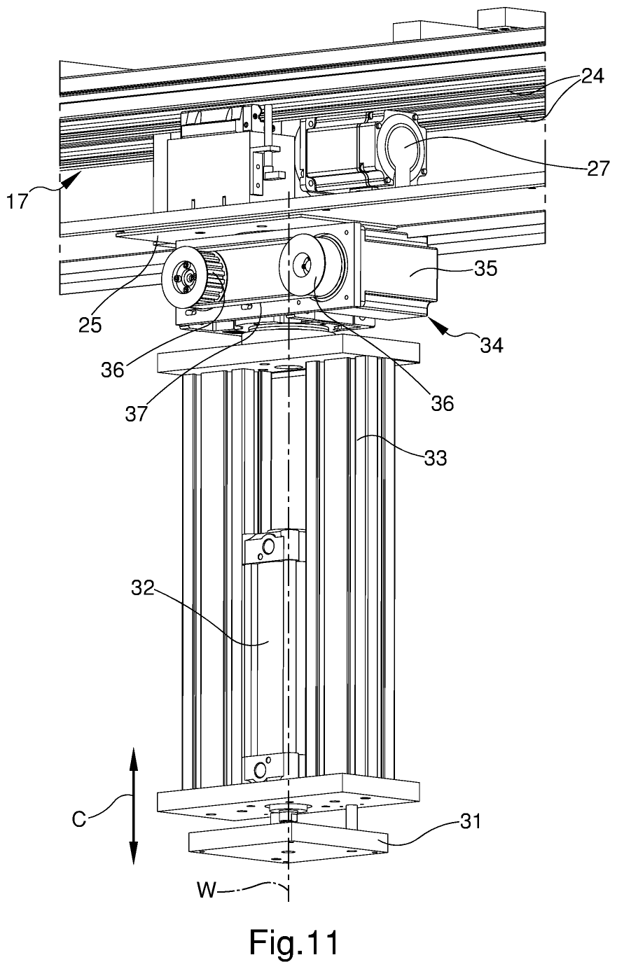

As shown in detail in FIG. 11, the actuating unit 34 comprises:
at least one motor device 35 associated with the slide 25; and
a set of sprockets 36 around which a flexible body 37 closed on itself in a loop is at least partly wound.

The motor device 35 is of the type, e.g., of an electric motor.

The motor device 35 is associated with one of the sprockets 36 and is adapted to set the latter in rotation.

Only two sprockets 36 are shown in FIG. 11, which are visible from the outside of the gripping head 152.

It is easy to understand that the gripping head 152 comprises one or more additional sprockets 36 that are not visible from the outside of the gripping head 152, wherein one of which is operationally connected to the framework assembly 33.

Through the flexible body 37, the rotational motion given by the motor device 35 is transmitted by the sprocket 36 associated with the latter to the other sprockets 36, thus causing the rotation of the framework assembly 33 around the axis of work W.

The gripping head 152 allows the slab L or portions thereof to be further moved in rotation around the axis of work W.

In addition, the presence of a gripping head 151 fixed in rotation and of a gripping head 152 rotatable around the axis of work W enables the machine 1 to adapt to specific production needs where, e.g., a portion of the slab L must be held firmly in place and an additional portion of the slab L must be moved.

It has in practice been ascertained that the described invention achieves the intended objects and in particular it is underlined that the machine for cutting slabs, particularly made of marble, granite, glass and composite materials, is made of greater structural simplicity than the machines of known type.

This significantly reduces the costs related to the construction of the machine itself.

In addition, the particular embodiment proposed makes the work area less cumbersome and safer for the operators who use it.

1) A machine for cutting slabs, particularly made of marble, granite, glass and composite materials, comprising:
a base frame;
a worktop for a slab to be cut, which is associated with said base frame;
a cutting head adapted to cut said slab, which is associated with said base frame by interposition of at least one transverse frame moveable to slide with respect to said base frame to displace said cutting head itself along a first direction that is substantially parallel to said worktop, said cutting head being moveable on said transverse frame along a second direction that is substantially parallel to said worktop and transverse with respect to said first direction;
gripping means of said slab, to grasp the slab, or to hold it or to grasp and hold it, associated with said base frame and moveable to slide with respect to said base frame along said first direction;
wherein said gripping means are associated with said transverse frame and moveable on said transverse frame along said second direction in an independent manner with respect to said cutting head.

2) The machine according to claim 1, wherein said machine comprises movement means associated with said transverse frame and adapted to move said cutting head and said gripping means along said second direction.

3) The machine according to claim 2, wherein said movement means comprise:
first movement means that extend along said second direction and on which said cutting head is mounted slidingly; and
second movement means, different from said first movement means, which extend along said second direction and on which said gripping means are mounted slidingly.

4) The machine according to claim 3, wherein said first movement means and said second movement means are arranged on opposite sides of said transverse frame with respect to a longitudinal plane substantially parallel to said second direction and transverse to said worktop.

5) The machine according to claim 3, wherein said second movement means comprise at least one motor assembly adapted to move said gripping means along said second direction.

6) The machine according to claim 5, wherein said gripping means comprise two gripping heads, each associated with a respective motor assembly and moveable independently the one with respect to the other along said second direction.

7) The machine according to claim 6, wherein each of said two gripping heads comprises at least one grasping element adapted to grasp, lift, drag and press said slab on said worktop.

8) The machine according to claim 7, wherein each of said two gripping heads comprises an actuator element adapted to displace said grasping element along a third direction substantially transverse to said worktop to move at least one of: (i) close to and (ii) away from said slab.

9) The machine according to claim 8, wherein said cutting head is moveable along said third direction to move at least one of: (i) close to and (ii) away from said slab.

10) The machine according to claim 1, wherein said machine comprises at least one movement assembly adapted to move said transverse frame with respect to said base frame along said first direction.

11) The machine according to claim 3, wherein said transverse frame comprises:
a first crossbeam extending along the second direction and on which said cutting head is mounted; and
a second crossbeam extending along said second direction, locked together with said first crossbeam and on which said gripping means are mounted;
said first movement means being mounted on said first crossbeam and said second movement means being mounted on said second crossbeam.

12) The machine according to claim 6, wherein at least one of said gripping heads is moveable in rotation around an axis of work substantially transverse to said worktop.

13) The machine according to claim 10, wherein said movement assembly comprises an actuator device mounted on said transverse frame and connected through a drive system to said base frame, said drive system comprising:
a pair of end wheels, each mounted at one respective end of said transverse frame; and
at least one flexible element closed on itself in a loop and wound at least partly around said end wheels;
each of said end wheels being associated with a relevant first threaded nut, which is screwed around a relevant first threaded shaft, substantially parallel to said first direction.

14) The machine according to claim 13, wherein said drive system comprises:
two main flexible elements, each wound at least partly around a relevant end wheel; and
an idler wheel mounted at an intermediate area of said transverse frame;
wherein said actuator device is associated with said idler wheel, said flexible elements being wound at least partly around said idler wheel.

15) The machine according to claim 14, wherein said drive system comprises:
multiple idler wheels mounted at intermediate areas of said transverse frame; and
at least one idler flexible element, positioned between said main flexible elements and at least partly wound around two of said idler wheels.
